(19) United States
(12) Patent Application Publication
(10) Pub. No.: US 2025/0123584 A1
(43) Pub. Date: Apr. 17, 2025

(54) IMAGE FORMING APPARATUS

(71) Applicant: CANON KABUSHIKI KAISHA, Tokyo (JP)

(72) Inventors: KENTA SHIBUKAWA, Shizuoka (JP); SHINICHI AGATA, Shizuoka (JP); HISASHI TANIGUCHI, Shizuoka (JP)

(21) Appl. No.: 18/910,110

(22) Filed: Oct. 9, 2024

(30) Foreign Application Priority Data
Oct. 17, 2023 (JP) 2023-178854

(51) Int. Cl. G03G 15/00; G03G 15/01; G03G 21/00

(52) U.S. Cl. CPC G03G 15/5058; G03G 15/0121; G03G 15/0189; G03G 21/0011

(57) ABSTRACT

An image forming apparatus includes a plurality of image forming units, each unit including an image bearing member, a developer carrying member that supplies developer to an electrostatic latent image to form a developer image, and a cleaning member that removes the developer from a surface of the image bearing member. The image forming apparatus further includes: an intermediate transfer member that carries the developer images of the respective units; a transfer unit that transfers superimposed developer images on the intermediate transfer member to a recording material; and a control unit that performs a toner supply process in which the developer is supplied from the developer carrying member to a region where the image bearing member and the cleaning member come into contact after a first image forming process of printing a high-coverage image and before a second image forming process.

### BACKGROUND OF THE INVENTION

### Field of the Invention

The present invention relates to an image forming apparatus.

### Description of the Related Art

Image forming apparatuses that use an electrophotographic or electrostatic recording system such as copiers, printers, or facsimiles are known. Some of these image forming apparatuses use a process cartridge removably mounted in the apparatus body, with a photosensitive drum, a developing unit, etc. integrated therein.

Also known is an in-line color image forming apparatus in which several photosensitive drums are arranged along the rotating direction of an intermediate transfer belt. In such an in-line image forming apparatus, an electrostatic latent image formed on the photosensitive drum is developed into a toner image with the toner supplied from a developing unit. The toner image is transferred to the intermediate transfer belt (primary transfer). The primary transfer is repeated similarly in several colors so that a full-color toner image is formed on the intermediate transfer belt. The full-color toner image is transferred onto a recording material (secondary transfer), and fixed by a fixing unit. Residual toner that was not transferred onto the recording material in the secondary transfer process and left on the intermediate transfer belt is removed by a cleaning unit that is in contact with the intermediate transfer belt.

After the primary transfer of the toner image, some substances originating from the toner such as residual toner and external additives remain adhered on the photosensitive drum. A cleaning unit having a blade is used to clean such residual toner and external additives left on the photosensitive drum. The blade in the cleaning unit is flexible and contacted to the photosensitive drum to remove the residual toner and external additives. External additives of the toner (externally added particles of supplementary additives other than the toner particle) that have migrated onto the photosensitive drum form a layer in the edge portion of the blade, and this layer serves as a barrier that helps the cleaning of the surface of the photosensitive drum. This layer will be hereinafter referred to as “block layer.” Japanese Patent Application Publication No. 2020-003718 shows a configuration in which toner containing additives externally added in advance is supplied from the developing unit to the cleaning blade to increase the thickness of the block layer for better cleaning performance.

### SUMMARY OF THE INVENTION

In such a configuration, sometimes, part of the block layer at the cleaning blade was destroyed in the image forming unit located downstream of the intermediate transfer belt, when a large number of high-coverage prints were produced (high-coverage images). Image formation in this condition would sometimes result in vertical streaks on the image due to faulty cleaning where toner has leaked through areas where the block layer has been destroyed.

Such faulty cleaning caused by destruction of the block layer often occurred during image formation after a calibration process that is performed for adjusting image density or color shift. This is because of the formation of high-coverage images during the calibration process for image adjustment, which causes a larger amount of highly charged toner to access the cleaning blade than during a normal image forming process, accelerating the destruction of the block layer at the cleaning blade.

The present invention was made in view of the issue described above. An object of the present invention is to provide an image forming apparatus that reduces occurrence of faulty cleaning even after formation of high-coverage images.

The present invention provides an image forming apparatus comprising:
a plurality of image forming units, each image forming unit including an image bearing member on which an electrostatic latent image is formed based on image information, a developer carrying member configured to supply developer to the electrostatic latent image to form a developer image, and a cleaning member configured to remove the developer from a surface of the image bearing member by making contact with the image bearing member;
an intermediate transfer member configured to carry the developer images that have been formed in the respective image forming units and transferred in sequence in superimposed manner;
a transfer unit configured to transfer the developer images superimposed on the intermediate transfer member to a recording material; and
a control unit configured to perform a toner supply process in which the developer is supplied from the developer carrying member to a region where the image bearing member and the cleaning member come into contact after a first image forming process of printing a high-coverage image and before a second image forming process that is an image forming process following the first image forming process.

The present invention can provide an image forming apparatus that reduces occurrence of faulty cleaning even after formation of high-coverage images.

Further features of the present invention will become apparent from the following description of exemplary embodiments with reference to the attached drawings.

### BRIEF DESCRIPTION OF THE DRAWINGS

FIG. 1 is a flowchart of a toner discharge sequence according to Embodiment 1;

FIG. 2 is a schematic cross-sectional view of an image forming apparatus in Embodiment 1;

FIG. 3 shows a cross section of a process cartridge in Embodiment 1;

FIG. 4 is a control block diagram of the image forming apparatus in Embodiment 1;

FIG. 5 shows a patch image used for correction of color shift in Embodiment 1;

FIG. 6 shows a patch image used for density correction in Embodiment 1;

FIG. 7 is an enlarged view of a cleaning blade edge; and

FIG. 8 is a flowchart of a toner discharge sequence according to Embodiment 2.

### DESCRIPTION OF THE EMBODIMENTS

Hereinafter, illustrative examples for carrying out the present invention will be described with reference to the drawings. It should be noted that, unless otherwise specified, the sizes, materials, shapes, and relative arrangement or the like of constituent components described in the embodiments are not intended to limit the scope of this invention. The components once described below as being of a certain material and having a certain shape should be understood to be of the same material and have the same shape in later descriptions thereof unless otherwise specifically stated. Existing or known techniques in the applicable technical field can be applied to the configurations or processes that are not illustrated or described in particular. Some repetitive descriptions may be omitted.

### Embodiment 1

### Description of Image Forming Apparatus

The overall configuration of an electrophotographic image forming apparatus according to Embodiment 1 will be described. The image forming apparatus here is an apparatus that forms images on a recording material (recording medium). Examples of the image forming apparatus include a copier, a printer (e.g., laser beam printer, LED printer), a facsimile, a word processor, and a multifunction machine consolidating all these functionalities (multifunction printer).

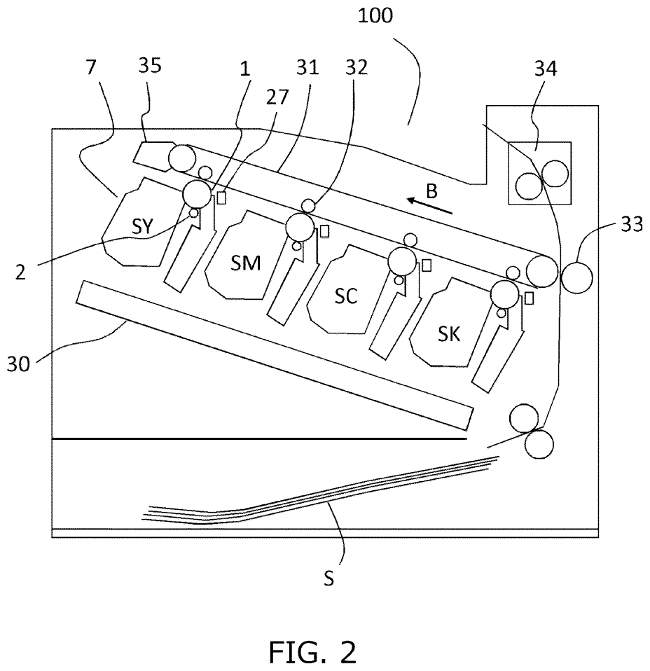

FIG. 2 is a schematic cross-sectional view of the image forming apparatus 100 according to Embodiment 1. The image forming apparatus 100 of Embodiment 1 is a full-color laser printer that adopts an in-line arrangement and an intermediate transfer system. The image forming apparatus 100 forms full-color images on a recording material S (such as, for example, recording paper, plastic sheet, fabric, etc.) in accordance with image information. The image information is input to the image forming apparatus 100 from an image reading unit such as a scanner connected to the image forming apparatus 100, or from a host machine such as a personal computer connected to and communicating with the image forming apparatus 100.

### Description of Process Cartridge and Image Formation

The image forming apparatus 100 includes a plurality of image forming units, which are, first, second, third, and fourth image forming units SY, SM, SC, and SK for forming yellow (Y), magenta (M), cyan (C), and black (K) images, respectively. When there is no need to distinguish the units, only the symbols will be used without the terms that indicate the respective colors. The image forming apparatus 100 includes four drum-shaped electrophotographic photosensitive members (also called photosensitive drums, hereinafter referred to as photosensitive member 1) arranged along a direction perpendicular to the vertical direction. Each photosensitive member 1 and each of the image forming units (SY, SM, SC, and SK) are united to form a process cartridge 7. The photosensitive members 1 are image bearing members that carry an electrostatic latent image.

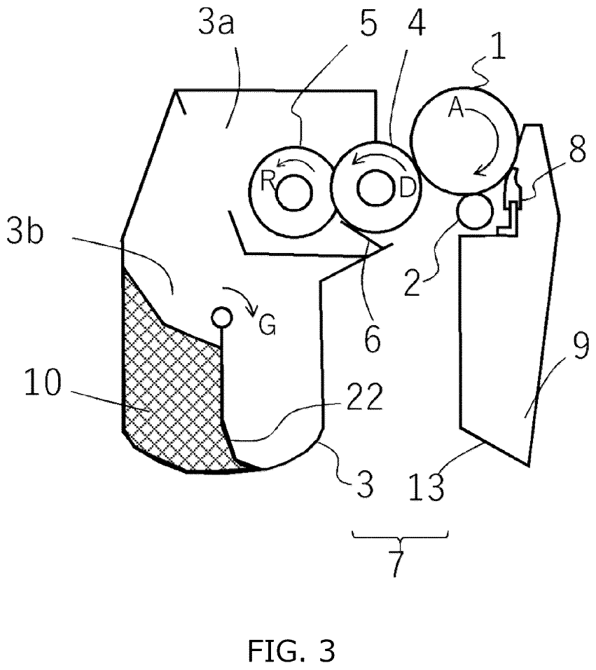

As shown in FIG. 3, each photosensitive member 1 is driven to rotate by a drive means (not shown) in the direction of arrow A. The charging roller 2, which is a charging member, is a single-layer roller made up of a conductive metal core and a conductive rubber layer. A charging voltage (−1000 V) is applied to the charging roller 2 by a charging voltage application unit 71, which is a high-voltage power supply, to charge the surface of the photosensitive member 1 uniformly (to −500 V). Here, a DC voltage Vd+Vth is applied to the charging roller 2, and the surface of the photosensitive member 1 is uniformly charged to Vd by discharging. Vd represents the dark potential (−500 V), and Vth represents the threshold voltage for discharge. When the charging voltage applied to the charging roller 2 by the charging voltage application unit 71 is lower than the threshold voltage for discharge Vth, the surface potential of the photosensitive member 1 does not increase by the discharge. When the charging voltage exceeds the threshold voltage for discharge Vth, the surface potential of the photosensitive member 1 increases by the discharge. The threshold voltage for discharge Vth in Embodiment 1 is −500 V.

After the surface of the photosensitive member 1 has been charged by the charging roller 2, a laser beam is emitted from an exposure unit 30 to the photosensitive member 1. The exposure unit 30 is an exposure means that forms an electrostatic latent image on the surface of the photosensitive member 1 by emitting laser based on the image information. The surface potential of the areas of the photosensitive member 1 irradiated with the laser beam changes to a light potential Vl (−100V), whereby an electrostatic latent image is formed on the surface of the photosensitive member 1.

FIG. 3 is a cross-sectional view of the process cartridge 7 in Embodiment 1 viewed in the longitudinal direction (direction of the rotation axis) of the photosensitive member 1. The process cartridge 7 is made up of a developing unit 3 and a photosensitive member unit 13. The developing unit 3 includes a developing roller 4 that is a developer carrying member, and a supply roller 5 that is a toner supplying member. The developing roller 4 rotates in the direction of arrow D in FIG. 2 by a drive force from a drive motor (not shown), and the supply roller 5 rotates in the direction of arrow R in FIG. 2. A developing voltage application unit 72 applies a developing voltage (−300 V) to the developing roller 4, so that developer (toner) is supplied by the developing roller 4 to the electrostatic latent image (i.e., the areas with the light potential Vl mentioned above) formed on the surface of the photosensitive member 1. The electrostatic latent image is thus developed into a developer image (toner image).

The toner image developed on the surface of the photosensitive member 1 is then transferred onto an intermediate transfer belt 31 shown in FIG. 2, which is an intermediate transfer member. The intermediate transfer belt 31 is an endless belt facing the respective photosensitive members 1 in the image forming units SY, SM, SC, and SK. The intermediate transfer belt 31 moves in circular path (rotates) in the direction of arrow B in FIG. 2 (counterclockwise) in contact with the respective photosensitive members 1 of the image forming units SY, SM, SC, and SK.

Primary transfer rollers 32, which are transfer members, are disposed opposite the respective photosensitive members 1 of the image forming units SY, SM, SC, and SK on the inner circumferential surface of the intermediate transfer belt 31. A voltage of the opposite polarity from that of the standard polarity of the toner is applied to the primary transfer rollers 32 by a primary transfer voltage application unit 73. The toner images on the photosensitive members 1 are thereby transferred onto the intermediate transfer belt 31 (primary transfer). The standard polarity of the toner in Embodiment 1 is negative. Therefore, the primary transfer voltage application unit 73 applies a positive voltage as the primary transfer voltage.

The recording material S stored in a cassette in a lower part of the apparatus body is transported to a secondary transfer unit by pick-up rollers and transport rollers. In the secondary transfer unit, a secondary transfer roller 33, which is a secondary transfer means, is disposed on the outer circumferential surface of the intermediate transfer belt 31. A voltage of the opposite polarity from that of the standard polarity of the toner is applied to the secondary transfer roller 33 by a secondary transfer voltage application unit 74, which is a secondary transfer voltage application unit. The toner image on the intermediate transfer belt 31 is thereby transferred onto the recording material S (secondary transfer).

When forming a full-color image, the images of respective colors formed in the image forming units SY, SM, SC, and SK are successively transferred onto the intermediate transfer belt 31 (primary transfer). After that, the recording material S is transported to the secondary transfer unit in sync with the movement of the intermediate transfer belt 31. The combined four-color toner image on the intermediate transfer belt 31 is then transferred onto the recording material S (secondary transfer) by the effect of the secondary transfer roller 33 making contact with the intermediate transfer belt 31 via the recording material S.

The recording material S carrying the transferred toner image is transported to a fixing assembly 34. Heat and pressure are applied to the recording material S in the fixing assembly 34 so that the toner image is fixed on the recording material S. The recording material S is then discharged to the outside of the image forming apparatus 100.

The toner that was not transferred by the primary transfer roller 32 to the intermediate transfer belt 31 and remaining on the surface of the photosensitive member 1 is scraped off from the surface of the photosensitive member 1 by a cleaning blade 8 shown in FIG. 3 making contact with the photosensitive member 1 as a cleaning member. The toner is then collected to a waste toner container 9 provided below the cleaning blade 8. Likewise, the toner that was not transferred onto the recording material S by the secondary transfer roller 33 and left on the intermediate transfer belt 31 is transported to a cleaning unit 35 for the intermediate transfer member and removed.

### Description of Control Block Diagram

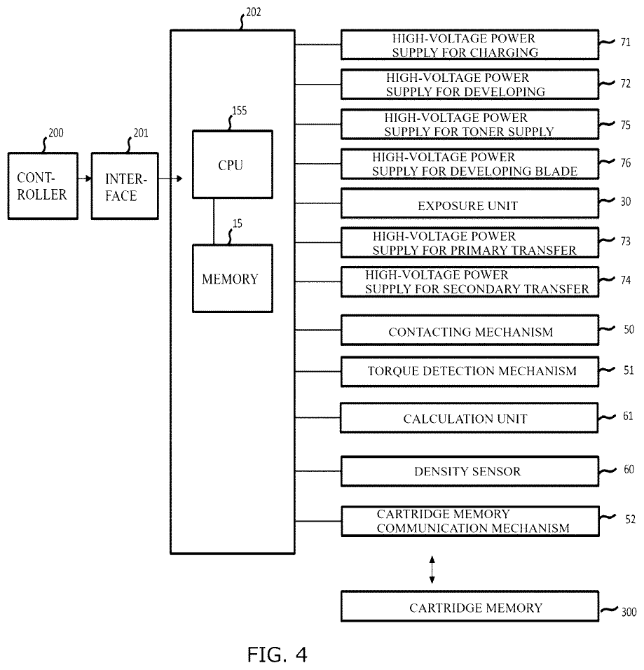

FIG. 4 is a block diagram showing the logical relations between the constituent elements of the image forming apparatus 100 in Embodiment 1. Signals indicating various pieces of information are input to and output from a control unit 202 via electrical connection for controlling the operation of the image forming apparatus 100. The control unit 202 processes the signals input from various processors and sensors, as well as the signals output to send commands to various processors. A controller 200 exchanges various signals with a host device, and with the control unit 202 via an interface 201, for overall control of the image forming operation of the image forming apparatus 100 in accordance with a predetermined control program and lookup tables.

The control unit 202 includes a CPU 155, which is the central unit that performs various arithmetic operations, and a memory 15, which is a memory unit such as a RAM or ROM. The RAM stores detection results of sensors, counting results of counters, operation results, and so on. The ROM stores control programs, and data tables obtained in advance through experiments and the like.

To the control unit 202 are connected various control targets, sensors, and counters of the image forming apparatus 100. The control unit 202 controls a predetermined image forming sequence by controlling the inputs and outputs of various signals and the driving timings of various units. For example, the control unit controls the high-voltage power supplies and the whole apparatus to form a toner image on the surface of the photosensitive member 1. The control targets include, for example, the charging voltage application unit 71 that is a charging power supply, the developing voltage application unit 72 that is a developing power supply, a toner supply voltage application unit 75 as a power supply for the supply roller 5, a developing blade voltage application unit 76 as a power supply for the toner restricting member 6, and the exposure unit 30. The control targets further include the primary transfer voltage application unit 73 that is a primary transfer power supply for forming toner images on the recording material S, the secondary transfer voltage application unit 74 that is a secondary transfer power supply, a contacting mechanism 50 that controls contact and separation of the developing roller 4 and the photosensitive member 1, a torque detection mechanism 51 for the drive motors of the photosensitive members 1, and a cartridge memory communication mechanism 52 that records the usage histories of the cartridges. The voltage application units may all be the same power supply, or configured as separate power supplies.

### Description of Calibration

Calibration is performed to correct image density shift or color shift that may occur depending on the environment in which the image forming apparatus is used or the number of prints. This process is described below. The control unit corrects the image forming conditions based on the calibration. Calibration is performed at predetermined times, such as when the image forming apparatus 100 starts to be used, when the number of prints has reached a preset number, or when the time of use of the apparatus has reached a preset value. Alternatively, the user may perform calibration at any time as needed.

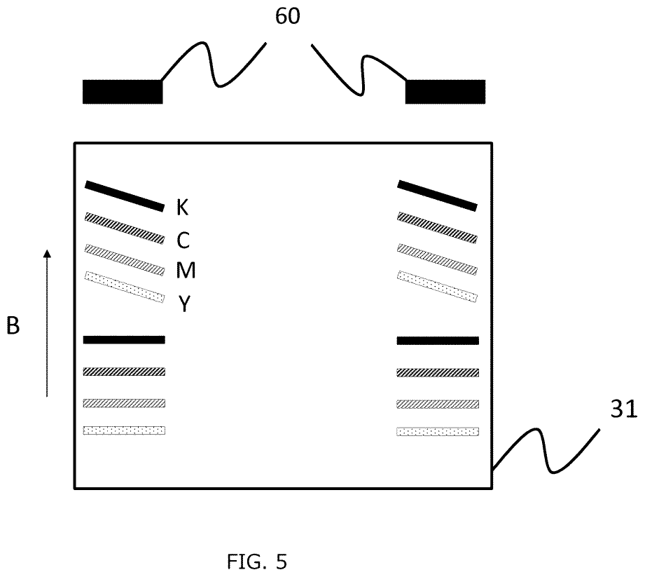

FIG. 5 shows one example of a patch image (reference image) for correction of color shift used in the calibration. In this embodiment, the reference image includes solid blocks of respective colors, black, cyan, magenta, and yellow, at both ends in the width direction of the intermediate transfer belt 31. The patch image is not limited to the example and can be changed to one that is suitable for the calibration, as the need may be. The patch image may for example be an image of a horizontal band of uniform density.

A density sensor 60 in this embodiment is provided opposite the intermediate transfer belt 31 to be able to detect the image density in the areas in the width direction of the intermediate transfer belt 31 where the reference images are formed. The density sensor 60 detects the reference images of respective colors that are transported thereto, and compares their positional relationship with that of predetermined reference positions. For example, if a detection result of the black reference image indicates a shift from the predetermined reference position in the main scanning direction (perpendicular to the transport direction of the intermediate transfer belt 31), it means that there is shift of black in the main scanning direction. Therefore, the control unit 202 adjusts the position of starting exposure in the exposure unit 30 for correcting the shift in the main scanning direction. Similarly, to correct shift in the sub scanning direction (transport direction of the intermediate transfer belt 31, intersecting the main scanning direction, typically at right angles), the control unit 202 adjusts the timing of starting exposure in the exposure unit 30.

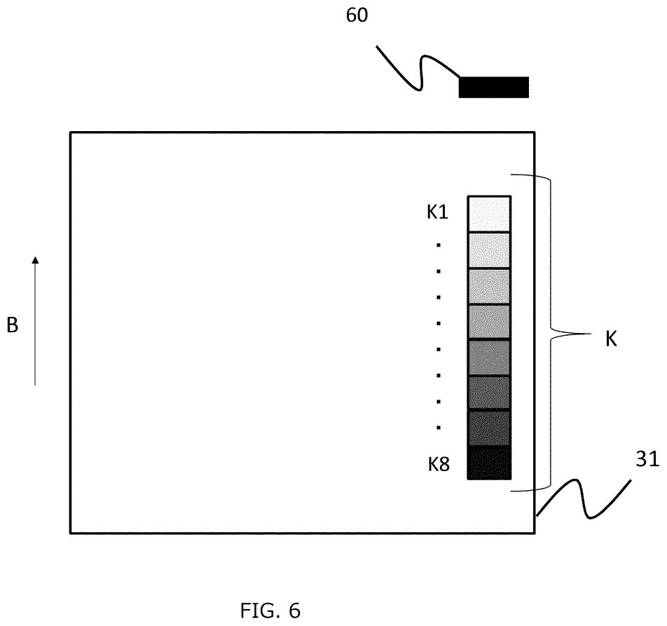

Next, how the density is corrected based on the calibration will be described with respect to the image forming unit SK for black as one example. FIG. 6 shows one example of a patch image (reference image) for density correction used in the calibration. A reference image K consisting of patch images K1 to K8 of eight density levels, from light K1 to darkest K8 (solid image) is formed along the belt moving direction at one end in the width direction of the intermediate transfer belt 31. The adjoining patch images are all monochrome, changing in density at each boundary.

The image density sensor 60 as a detection means detects the densities of the patch images K. The control unit 202 compares the detected densities with predetermined reference densities and calculates the differences between the respective toner densities and the reference densities. The control unit 202 then reads out parameters from a density correction table to be used for the density correction in accordance with the obtained density differences, and performs the density correction. For example, if the density in a patch image K is lower than the reference density, the amount of toner during image formation may be increased according to the density difference. The densities of the colors other than black can also be corrected similarly based on a difference between the detected density and the reference density.

### Toner Supply to Cleaning Blade

Next, how toner is supplied to the cleaning blade 8 will be described with respect to the image forming unit SK for black as one example. Toner is supplied to the cleaning blade 8 in this embodiment during the time when no images are being formed. The time when no images are being formed refers to a period during which image formation is not being performed in accordance with an instruction from a host device or via an operation panel. Similarly to the times for performing calibration, the period may for example be at the start of use of the apparatus, or during a regular maintenance, or at any time determined by the user as needed. At the time when toner is supplied to the cleaning blade 8, the developing roller 4 and the photosensitive member 1 are kept in contact with each other as they were during image formation. The process of supplying toner to the cleaning blade 8 is performed after the image formation has ended.

Toner is supplied to the cleaning blade 8 by the same process as the process of forming the toner image during image formation. Namely, an electrostatic latent image is formed by charging and exposing the surface of the photosensitive member 1, and a toner image is formed by the developing roller 4 that supplies toner. In this embodiment, a uniform, solid image of a horizontal band was formed along the longitudinal direction. During toner purging, a negative voltage is applied to the primary transfer roller 32 to leave this toner image on the photosensitive member 1 to prevent the toner image from being transferred onto the intermediate transfer belt 31. The toner forming this image on the photosensitive member 1 that was not transferred is all supplied to the edge of the cleaning blade 8.

### Description of Block Layer Formation

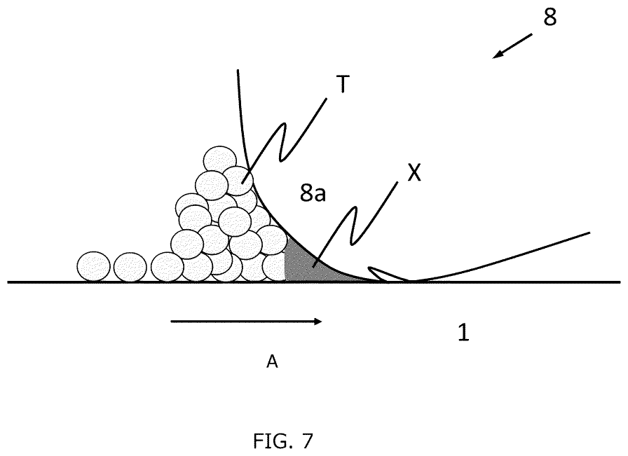

The cleaning mechanism and the formation of the block layer X will be described with reference to FIG. 7, which shows an enlarged view of an edge portion 8a of the cleaning blade 8. The cleaning blade 8 is in contact with the photosensitive member 1 counter to the rotating direction A of the photosensitive member 1, with the edge portion 8a of the cleaning blade 8 being rolled in as the photosensitive member 1 rotates. External additives in the toner, having a smaller particle size than toner T, are entrapped in the wedge-shaped space formed by the rolled edge portion. The external additives thus accumulated in the wedge-shaped space form the block layer X. Namely, when the toner is supplied to the cleaning blade 8, the external additives contained in the supplied toner gather around the edge portion, whereby the block layer X is formed.

This block layer X serves the function of a barrier that helps clean the toner off the photosensitive member 1. Without the block layer X, the toner can more readily enter the wedge-shaped space formed by the rolled edge portion 8a, so that the toner can more easily leak through the cleaning blade 8, resulting in faulty cleaning.

### Destruction of Barrier Layer

Next, the mechanism of destruction of the block layer X will be explained. The toner image formed on the photosensitive member 1 is transferred to the intermediate transfer belt 31 in the transfer unit located at the transfer position. The discharging that occurs at this time in the transfer unit creates a highly charged toner. Some of the highly charged toner migrates to the photosensitive member 1. Highly charged toner and external additives have a high electrical bond with the photosensitive member 1. Therefore, the highly charged toner and external additives reaching the edge of the cleaning blade 8 require a large force to be scraped off the photosensitive member 1, leading to the destruction of part of the block layer X.

A large amount of such highly charged toner accessing the cleaning blade accelerates the destruction of the block layer X. Once broken, the block layer X may be depleted in some areas in the longitudinal direction of the edge portion. The block layer X with some areas missing causes insufficient toner cleaning, allowing the toner to leak through, resulting in vertical streaks in the next pass of image formation.

The highly charged toner migrates and adheres to the intermediate transfer belt 31 when the toner image on the photosensitive member 1 is transferred to the intermediate transfer belt 31 by a bias voltage at the transfer position. The adhering highly charged toner builds up gradually as the image transfer progresses from upstream image forming units to downstream image forming units. The most downstream image forming unit in the transport direction of the intermediate transfer belt 31 (typically, the black image forming unit) is most susceptible to the influence of the toner images that have been formed in all the upstream image forming units. Therefore, the further downstream an image forming unit is located in the moving direction of the intermediate transfer belt 31, the more amount of highly charged toner is collected, and the more likely it is that faulty cleaning will occur due to depletion of the block layer X. Accordingly, to prevent faulty cleaning, it is necessary to restore the block layer X, even though it may be destroyed once, before the next image forming process. The necessity is higher in particular, the further downstream the image forming unit is in the direction of movement of the intermediate transfer belt.

Toner Discharge Sequence according to Embodiment

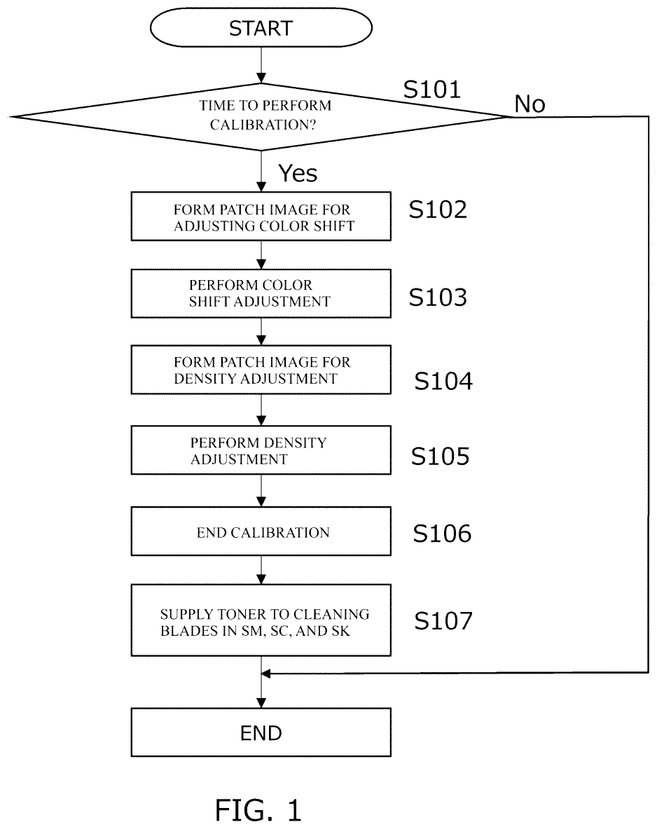

The timing of performing the toner discharge sequence in this embodiment will be described with reference to the flowchart of FIG. 1. The sequence starts at the time when the image forming apparatus 100 starts to operate. At step S101, the control unit 202 determines whether or not the time has come to carry out calibration based on the number of prints. The process ends when the control unit determines that it is not the time yet to perform calibration (S101=No).

When the control unit determines that it is time to perform calibration (S101=Yes), the control unit 202 forms a patch image for adjusting color shift in the manner described above (step S102), and makes adjustments to color shift (step S103). Successively, the control unit 202 forms a density patch image (step S104), and performs density adjustment (step S105). Following this procedure, the control unit 202 confirms that the calibration has been completed (step S106).

After the calibration, the control unit 202 supplies toner to the cleaning blades 8 of the image forming units SM, SC, and SK that are located downstream in the transport direction of the intermediate transfer belt 31 (step S107). In this embodiment, solid images of horizontal bands were used for supplying toner to the cleaning blades 8 in the respective image forming units. The horizontal bands were 20 mm, 40 mm, and 60 mm in width, in the transport direction, for the image forming units SM, SC, and SK, respectively. As mentioned before, the destruction of the block layer X is more advanced, the further downstream the image forming unit is in the transport direction of the intermediate transfer belt 31. Therefore, in this embodiment, more toner is supplied to the cleaning blade 8 in the image forming unit that is located more downstream of the intermediate transfer belt 31. There is no other image forming unit upstream of the image forming unit SY located most upstream of the intermediate transfer belt 31, so that the destruction of the block layer X does not progress by collection of highly charged toner. Therefore, in this embodiment, no toner is supplied to the cleaning blade 8 in the image forming unit SY after the calibration. Of course, toner may be supplied to the most upstream image forming unit SY to ensure formation of the block layer X.

### Effects

The effects of Embodiment 1 will be described with reference to Table 1. Here, the effects of this embodiment and comparative examples observed in the black image forming unit SK located most downstream of the intermediate transfer belt 31 were checked. It was checked whether there were vertical streaks in the prints due to faulty cleaning after calibration was performed in respective conditions. The conditions of Embodiment 1, and Comparative Examples 1 and 2 are as follows.
Embodiment 1: Toner was supplied to the cleaning blade 8 after the calibration
Comparative Example 1: Toner was supplied to the cleaning blade 8 before the calibration
Comparative Example 2: No toner was supplied to the cleaning blade 8

TABLE 1

| | Toner Supply | | Vertical Streaks |
|---|---|---|---|
| | to Cleaning | Toner Supply | in Image |
| | Blade | Timing | after Calibration |
| Embodiment 1 | Supplied | After Calibration | ◯ |
| Comparative | Supplied | Before Calibration | Δ |
| Example 1 | | | |
| Comparative | Not Supplied | — | X |
| Example 2 | | | |

◯: None
Δ: Slightly
X: Occurred

As shown in Table 1, no faulty cleaning occurred in the configuration of the embodiment. Slight vertical streaks due to faulty cleaning were found in Comparative Example 1. Comparative Example 2 ended up with vertical streaks due to faulty cleaning. This is because the block layer X that serves as a barrier layer was rebuilt at the edge portion of the cleaning blade 8 by the toner supplied to the cleaning blade 8 in this embodiment, so that the cleaning performance of the cleaning blade 8 was restored by the next image forming process. On the other hand, in Comparative Example 1 where toner was supplied before the calibration, the block layer was destroyed due to the formation of the high-coverage image in the calibration process, as a result of which slight image defects were observed. In Comparative Example 2 where no toner was supplied, severe image defects were observed.

As described above, according to the configuration in this embodiment, even when a large amount of highly charged toner has reached the cleaning blade 8 due to the formation of high-coverage images (first image forming process) such as those printed during calibration, the block layer X is rebuilt by supplying toner after that. This allowed the image forming apparatus to prevent faulty cleaning in image formation that followed the formation of the high-coverage image (second image forming process).

In this embodiment, a solid image of a horizontal band extending in the width direction of the intermediate transfer belt 31 was used as the toner image for supplying toner to the cleaning blade 8. The toner image for supplying toner may be changed as appropriate and the same effects will be achieved. For example, an image that will provide much toner to areas corresponding to the positions of the patch images (reference images) during the calibration can provide the same effects.

### Embodiment 2

Embodiment 2 will be described. The description of the same components as those of previously described embodiment 1 will be omitted or simplified as appropriate. In Embodiment 1, toner was supplied based on the timing of calibration. In Embodiment 2, high-coverage image formation is detected, and toner is supplied after the image formation.

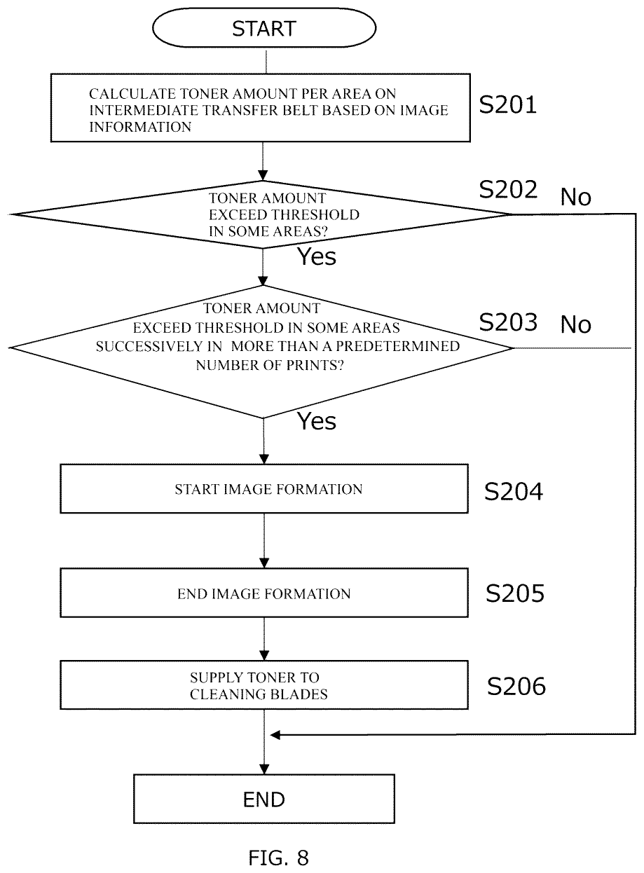

The timing of performing the toner discharge sequence in this embodiment will be described with reference to the flowchart of FIG. 8. The sequence starts at the time when the image forming apparatus 100 starts to operate. The control unit 202 acquires image information from the controller 200. The control unit 202 calculates the amount of toner to be transferred to the intermediate transfer belt 31 based on the acquired image information (step S201). In this embodiment, the intermediate transfer belt 31 was divided in the width direction (main scanning direction) into 10 areas and the amount of toner was calculated for each area. The length in the sub scanning direction may be a length of one recording material, for example.

Next, the control unit 202 determines whether or not the calculated amount of toner on the intermediate transfer belt 31 is more than a predetermined threshold for each area (step S202). If there is no area where the amount of toner exceeds the threshold, the process is ended. If there is an area where the amount exceeds the threshold, the process of determining the toner amount according to the image information is carried out successively in the next printing and onwards. The control unit determines whether or not there is a succession of a predetermined number of prints or more with the toner amount exceeding the threshold (step S203). When it is determined that the amount of toner to be transferred to the intermediate transfer belt 31 will exceed the threshold in the predetermined number of images or more (step S203=Yes), the process goes to step S204, where the image formation is started based on the image information. After the image formation at step S205, the control unit 202 supplies toner to the cleaning blade 8 (step S206).

### Effects

The effects of Embodiment 2 will be described with reference to Table 2. Here, the effects of this embodiment and comparative examples observed in the black image forming unit SK located most downstream of the intermediate transfer belt 31 were checked. This embodiment simulated a case where images were formed on two A4 sheets, and the number of division in the main scanning direction was 1 (i.e., the toner amount was calculated without dividing the image in the main scanning direction). Thus the amount of toner was calculated for the area that was 210 mm in width and 594 mm in length (corresponding to two A4 sheets). The control unit 202 in this embodiment calculated the amount of toner based on the information of images to be formed on the two sheets. Namely, in the process sequence performed here, the result at S202 in FIG. 8 was Yes, and the predetermined number of sheets was two. The threshold was a value that was 80% of the maximum amount of toner that could be carried on the intermediate transfer belt 31 by design. In this embodiment, a solid image of a horizontal band was used for supplying toner to the cleaning blade 8. The width of the area supplied with toner in the image forming unit SK (width of the horizontal band) was 60 mm.

In Embodiment 2, and Comparative Examples 3 and 4, it was checked whether there were vertical streaks caused by faulty cleaning in the image formed after a series of high-coverage printing in respective conditions. Table 2 shows the results. A series of high-coverage printing here corresponds to continuous printing with a coverage that requires an amount of toner higher than the threshold (80% of maximum amount of toner) on two A4 sheets. The conditions of Embodiment 2, and Comparative Examples 3 and 4 are as follows.
Embodiment 2: Toner was supplied to the cleaning blade 8 after high-coverage image formation
Comparative Example 3: Toner was supplied to the cleaning blade 8 before high-coverage image formation
Comparative Example 4: No toner was supplied to the cleaning blade 8

TABLE 2

| | Toner Supply | | Vertical Streaks in |
|---|---|---|---|
| | to Cleaning | Toner Supply | Image after High- |
| | Blade | Timing | Coverage Print |
| Embodiment 2 | Supplied | After High- | ◯ |
| | | Coverage Print | |
| Comparative | Supplied | Before High- | Δ |
| Example 3 | | Coverage Print | |
| Comparative | Not Supplied | — | X |
| Example 4 | | | |

◯: None
Δ: Slightly
X: Occurred

As shown in Table 2, no faulty cleaning occurred in the configuration of the embodiment. Slight vertical streaks due to faulty cleaning were found in Comparative Example 3. Comparative Example 4 ended up with vertical streaks due to faulty cleaning. The reason is the same as in Embodiment 1. Namely, the block layer X that serves as a barrier layer was rebuilt at the edge portion of the cleaning blade 8 by the toner supplied to the cleaning blade 8 in this embodiment, so that the cleaning performance was restored by the next image forming process and faulty cleaning was prevented. On the other hand, in Comparative Example 3 where the toner was supplied before the high-coverage image formation, the block layer was destroyed during the formation of the high-coverage image, as a result of which slight image defects were observed. In Comparative Example 4 where no toner was supplied, severe image defects were observed.

As described above, the configuration in this embodiment allowed the image forming apparatus to prevent faulty cleaning in image formation even after a series of printing of high-coverage images that causes a large amount of highly charged toner to reach the cleaning blade 8.

In this embodiment, a solid image of a horizontal band was used as the toner image for supplying toner to the cleaning blade 8. The same effects will be achieved by supplying toner only to some of the divided areas of the intermediate transfer belt 31 where the toner supply conditions are met. The number or method of dividing the intermediate transfer belt 31 when determining whether or not an image being formed is a high-coverage print based on the image information are not limited to the above example.

As described above, according to the present invention, the depleted block layer can be rebuilt by supplying toner to the cleaning blade after the first image forming process (e.g., high print-coverage image formation or calibration). As a result, faulty cleaning in the next image forming process (second image forming process) can be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-178854, filed on Oct. 17, 2023, which is hereby incorporated by reference wherein in its entirety.

What is claimed is:

1. An image forming apparatus comprising:
a plurality of image forming units, each image forming unit including an image bearing member on which an electrostatic latent image is formed based on image information, a developer carrying member configured to supply developer to the electrostatic latent image to form a developer image, and a cleaning member configured to remove the developer from a surface of the image bearing member by making contact with the image bearing member;
an intermediate transfer member configured to carry the developer images that have been formed in the respective image forming units and transferred in sequence in superimposed manner;
a transfer unit configured to transfer the developer images superimposed on the intermediate transfer member to a recording material; and
a control unit configured to perform a toner supply process in which the developer is supplied from the developer carrying member to a region where the image bearing member and the cleaning member come into contact after a first image forming process of printing a high-coverage image and before a second image forming process that is an image forming process following the first image forming process.

2. The image forming apparatus according to claim 1, wherein
the developer images are transferred from the plurality of image forming units to the intermediate transfer member in sequence from upstream to downstream in a transport direction of the intermediate transfer member, and
the control unit is configured to supply the developer in the toner supply process in an increasing amount in downstream image forming units.

3. The image forming apparatus according to claim 1, wherein
the first image forming process is a calibration process for correcting image forming conditions.

4. The image forming apparatus according to claim 3, further comprising a detection unit,
wherein,
the control unit is configured to form the developer image of a reference image for the calibration on the intermediate transfer member,
the detection unit is configured to detect a density of the reference image, and
the control unit is configured to perform the calibration by comparing the density of the reference image detected by the detection means with a predetermined reference density.

5. The image forming apparatus according to claim 4, wherein
the control unit is configured to supply the developer to an area corresponding to the reference image in a width direction in the toner supply process, the width direction being perpendicular to a transport direction of the intermediate transfer member.

6. The image forming apparatus according to claim 4, wherein
the control unit is configured to supply the developer in the toner supply process using an image of a horizontal band extending in a width direction that is perpendicular to a transport direction of the intermediate transfer member.

7. The image forming apparatus according to claim 1, wherein
the control unit is configured to calculate an amount of developer when an image is formed in the image forming units based on the image information, and to perform the toner supply process before a next image forming process when the amount of developer exceeds a predetermined threshold.

8. The image forming apparatus according to claim 7, wherein
the control unit is configured to calculate the amount of developer for each of a plurality of divided areas in a width direction that is perpendicular to a transport direction of the intermediate transfer member, and to supply the developer to one or more of the areas where the amount of developer exceeds the predetermined threshold.

9. The image forming apparatus according to claim 7, wherein
the control unit is configured to supply the developer in the toner supply process using an image of a horizontal band extending in a width direction that is perpendicular to a transport direction of the intermediate transfer member.
